(19) United States
(12) Patent Application Publication
(10) Pub. No.: US 2003/0229970 A1
(43) Pub. Date: Dec. 18, 2003

(54) Shock-absorbing protective cover for pneumatic tool handle

(76) Inventor: Li Chen Chen, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/173,404

(22) Filed: Jun. 18, 2002

(51) Int. Cl. B25D 17/04

(52) U.S. Cl. 16/430

(57) ABSTRACT

A shock-absorbing protective cover for pneumatic tool handle is made of a rubber material having a predetermined thickness to define a central through hole, into which the handle of a pneumatic tool is positioned. The protective cover is provided at predetermined positions with axially extended slots, in each of which a plurality of pointed-topped protrusions are continuously provided to form a plurality of spaced inverted pyramidal recesses. The recesses reduce a coefficient of elasticity of the rubber material at areas of the protective cover being gripped by a user, so that the protective cover under an applied force quickly deforms and absorbs energy, and slowly restores from the deformation and releases energy to provide shock absorbing and damping effects.

### BACKGROUND OF THE INVENTION

The present invention relates to a shock-absorbing protective cover, and more particularly to a protective cover that is put on a handle of a pneumatic tool to provide shock absorbing and damping effects and therefore protects a user's hands against injury caused by vibrated pneumatic tool.

The handles for currently commercially available pneumatic tools may be generally divided into three types in accordance with their designs:

1. A rigid metal handle formed at the time a main body of the pneumatic tool is molded.

2. A rigid handle coated with a plastic cover to isolate a user's hand from the cold touch of the rigid metal handle and to provide good friction for firm holding of the handle. The plastic cover also provides good visual effect.

3. A rigid handle coated with a rubber protective cover to provide limited elasticity and anti-slipping effect, and to increase friction of the handle for firm holding thereof.

None of the above three types of handles provides buffering and damping effects. A user's hands are subjected to vibration and reactive impact produced in the process of operating the pneumatic tool. The user's fingers and palm are easily becoming tired, sore, or even numb when they have been used to manipulate the pneumatic tool for a prolonged time. The tired and sore hands inevitably reduce working efficiency and stability of operation, and might result in serious stiffness or pains.

### SUMMARY OF THE INVENTION

A primary object of the present invention is to provide a shock-absorbing protective cover for pneumatic tool handle that provides good shock absorbing and damping effects, enabling a user to hold the pneumatic tool comfortably to achieve good working efficiency without the risk of injured hands due to the vibrated pneumatic tool.

To achieve the above and other objects, the protective cover for pneumatic tool handle according to the present invention is made of a rubber material having a predetermined thickness to define a central through hole, into which the handle of a pneumatic tool is positioned The protective cover is provided at predetermined positions with axially extended slots, in each of which a plurality of pointed-topped protrusions are continuously provided to define a plurality of spaced inverted pyramidal recesses. The recesses reduce a coefficient of elasticity of the rubber material at areas of the protective cover being gripped by a user, so that the protective cover under an applied force quickly deforms and absorbs energy, and slowly restores from deformation and releases energy to provide shock absorbing and damping effects.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a shock-absorbing protective cover of the present invention;

FIG. 2 is a cross sectional view taken on line A-A′ of FIG. 1;

FIG. 3 is a cross sectional view taken on line B-B′ of FIG. 1;

FIG. 4 shows the present invention is used with an impact wrench; and

FIG. 5 shows the present invention is used with a pneumatic stapler.

### DETAILED DESCRIPTION OF THE PREFERRED EMBODIMENTS

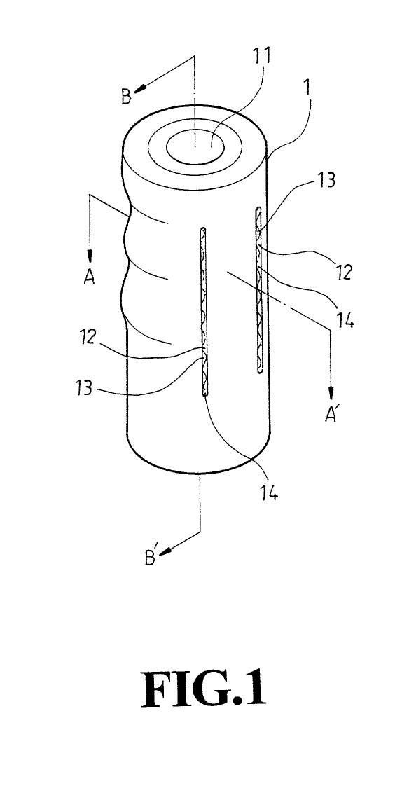

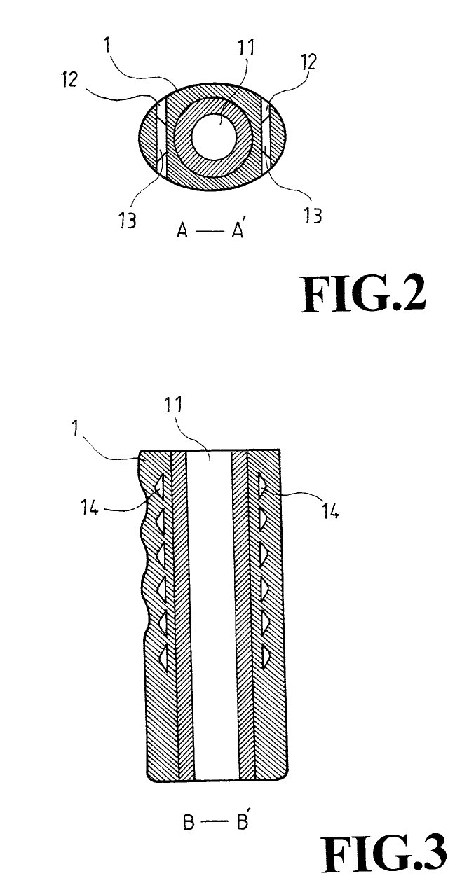

Please refer to FIGS. 1 to 3 at the same time. The present invention relates to a protective cover 1 made of a rubber material having a predetermined thickness. The protective cover 1 has a central through hole 11, into which a handle of a pneumatic tool is positioned. Two or more axially extended slots 12 are provided on the protective cover 1 at predetermined positions to space from each other by a predetermined distance. In the illustrated embodiment of the present invention, two slots 12 are symmetrically provided at two opposite sides of the protective cover 1. A plurality of pointed-topped protrusions 13 are continuously provided in each slot 12, so that a plurality of spaced inverted pyramidal recesses 14 are formed among the adjacent protrusions 13 in the slots 12. When the protective cover 1 is put over the handle of a pneumatic * tool, the spaced recesses 14 in the slots 12 reduce a coefficient of elasticity of the rubber material at areas of the protective cover 1 being gripped. That is, the rubber protective cover 1 quickly deforms to absorb energy when a force is applied thereto, and then slowly restores from the deformation and releases the absorbed energy to provide shock absorbing and damping effects.

Since the recesses 14 enable the protective cover 1 to deform easily under an applied force, a user may grip the handle of the pneumatic tool with fingers and palm more fitly and comfortably bearing against the handle and therefore manipulating the tool easily.

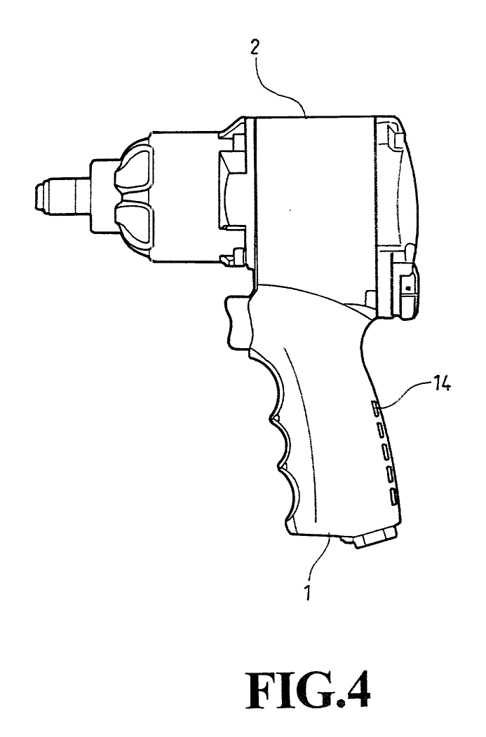

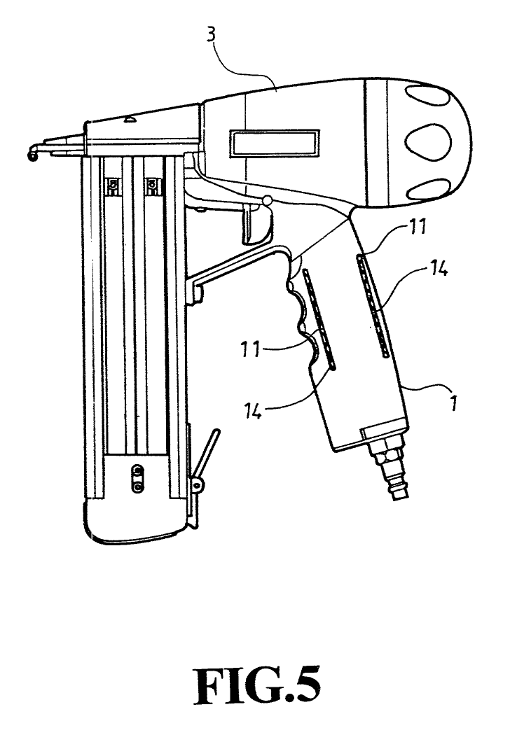

The protective cover 1 of the present invention may be used with different types of pneumatic tools. FIG. 4 shows the protective cover 1 is put on the handle of an impact wrench 2, and FIG. 5 a pneumatic stapler 3. The protective cover 1 of the present invention provides sufficient shock absorbing and damping effects to protect a user against injured hands due to vibration and reactive impact in operating the pneumatic tool.

What is claimed is:

1. A shock-absorbing protective cover for pneumatic tool handle, comprising a cover made of a rubber material having a predetermined thickness to define a central through hole, into which a pneumatic tool handle is positioned; said protective cover being characterized in that a predetermined number of axially extended slots are provided at predetermined positions on said protective cover to space from one another by a predetermined distance, and that each of said slots is internally provided with a plurality of continuously arranged pointed-topped protrusions, so that a plurality of inverted pyramidal recesses are formed among and spaced by said protrusions in said slots; and said spaced recesses being adapted to reduce a coefficient of elasticity of said rubber material at areas on said protective cover being gripped by a user, allowing said protective cover to quickly deform and absorb energy under an applied force and to slowly restore from the deformation and release energy to provide shock absorbing and damping effects.
